(19) United States
(12) Patent Application Publication
(10) Pub. No.: US 2014/0277708 A1
(43) Pub. Date: Sep. 18, 2014

(54) Device, System, and Method for Providing Bulk Units

(71) Applicants: Jack Bertram Coronel, Las Vegas, NV (US); Joseph R. Coronel, Las Vegas, NV (US)

(72) Inventors: Jack Bertram Coronel, Las Vegas, NV (US); Joseph R. Coronel, Las Vegas, NV (US)

(21) Appl. No.: 13/841,501

(22) Filed: Mar. 15, 2013

(51) Int. Cl. G06F 17/00

(52) U.S. Cl. CPC G06F 17/602
USPC 700/238

(57) ABSTRACT

A system, device, and method are directed to distributing and applying at least one benefit to units within a bulk quantity of units as they are redeemed. An election is received, optionally in response to a display, of a first quantity of units and a bulk quantity of units. When the first quantity of units is elected, units from the first quantity of units are provided without any additional benefits. When the bulk quantity of units is elected, units from the bulk quantity of units are provided with a benefit distributed across the units which is applied as units from the bulk quantity of units are redeemed.

### FIELD OF THE INVENTION

The present invention relates to systems, devices and methods for vending goods and services. More particularly, the present invention includes a device, system, and method for vending goods and services in bulk and providing a benefit for bulk redemption of goods and services.

### BACKGROUND OF THE INVENTION

It is well known in the art to sell goods at a price discount. For example, it is known to provide promotional pricing in which goods may be offered at “buy one, get one free” or “ten percent off orders of five or more” prices. Similarly, greater quantities of goods or services may be sold at a discounted price compared to a unit price. For example, one 32 ounce bottle may be priced substantially less than four 8 ounce bottles. Such pricing is logical since greater volumes are often more efficient to produce, package, and ship, thereby reducing associated costs. However, such promotions rely solely on pricing to provide an incentive to purchase greater volumes.

Similarly, within certain industries, it is known to sell packaged or grouped services. For example, in the gaming industry, U.S. Pat. No. 6,077,163, to Walker, discloses a flat rate play session in which a player purchases a flat rate play session and is guaranteed a certain amount of play regardless of the individual outcomes of the games in the flat rate play session. Thus, if the player loses all the games within a flat rate play session, the player is only liable for the initial purchase price. There is no benefit provided to the player except that U.S. Pat. No. 6,077,163 discloses a possible discount of the play session based on, for example, the player's rating, the usage of the gaming machine, the time of day, or the like. Thus, like prepackaged goods, U.S. Pat. No. 6,077,163 relies solely on pricing to provide an incentive to the player to purchase a flat rate play session. During those times when the flat rate play session is not discounted, there would be no difference between the flat rate play session and wagering on the same quantity of games separately.

Parlays are another form of bets known in the gaming industry. In a parlay, a bettor predicts the outcomes of multiple events (e.g., races, sporting events, etc.) and places a single wager. A payout is issued to the bettor if a threshold quantity of outcomes were correctly predicted. Although parlays rely on multiple events to be resolved, parlays are not truly multiple bets aggregated together. Rather, parlays are a single bet relying on multiple outcomes to resolve the single bet.

U.S. Pat. No. 6,488,281, to Stupak, discloses a variation on parlay bets in which the player's loss is limited at half of his or her original bet. According to U.S. Pat. No. 6,488,281, the bet may be viewed as “in effect” allowing the player to bet on multiple games, with a payout being guaranteed for correctly predicting more than a threshold quantity of games, and the player's loss being limited to half the original bet if the player correctly predicts fewer than the threshold quantity of games. However, U.S. Pat. No. 6,488,281 is merely a modified parlay bet with a single bet that requires the aggregate of multiple events to resolve the single wager.

### SUMMARY OF THE INVENTION

The present invention includes a method, system, and device for providing an additional benefit, independent of price discount, in the digital sale of goods and services. In one optional embodiment, a system includes at least one data processor, a user interface in communication with the data processor, and a data storage device in communication with the data processor. In a further optional embodiment, the device includes a display in communication with the data processor.

The data storage device stores program instructions executable by the data processor. In one optional embodiment, the program instructions are executable by the data processor to receive an election through the user interface of a first quantity of units or a bulk quantity of units. Optionally, the program instructions include displaying an option at the display to elect a first quantity of units and a bulk quantity of units, thereby prompting the election.

When the first quantity of units is elected, the data processor issues the first quantity of units without any additional benefit. Conversely, when the bulk quantity of units is elected, the data processor issues the bulk quantity of units and at least one benefit distributed over one or more designated units within the bulk quantity of units. In an optional embodiment, the benefit is distributed to a plurality of units within the bulk quantity of units.

A data processor receives a command to redeem units from the bulk quantity of units. Optionally, the command to redeem units is received through the user interface. In response, the data processor applies the benefit to one or more of the units. In an optional embodiment, application of the benefit to any one unit within the bulk quantity of units does not exhaust the benefit distributed to any other unit within the bulk quantity of units. In another optional embodiment, application of the benefit may be limited such that application of the benefit to certain units may exhaust the benefit, leaving the benefit unavailable for other units within the bulk quantity of units.

For example, in one optional embodiment, each unit comprises a digital good stored at the data storage device. The digital good may take any form, such as one or more event admissions, one or more games, one or more turns to conduct a game, or the like. In one such optional embodiment, each unit comprises a basic digital good stored at the data storage device. The basic digital good has at least one basic digital good attribute and the benefit comprises converting at least one of the basic digital goods within the bulk quantity of units into an enhanced digital good having at least one enhanced attribute unavailable in the basic digital good.

Thus, as applied to an example in which the digital good is a game, each unit may include at least one basic game stored at the data storage device. The basic game has at least one basic game attribute. In one such optional embodiment, when the bulk quantity of games is selected and redeemed, a benefit is distributed across the units of the bulk quantity of units. In one such optional embodiment, the benefit converts at least one of the basic games within the bulk quantity of units into an enhanced game with at least one enhanced attribute unavailable in the basic game. Similarly, in an example in which each digital good is a play or turn of a game, selection and redemption of a bulk quantity of games results in distribution of a benefit across the bulk quantity of plays or turns of the game. In an optional embodiment, the benefit converts at least one of the plays or turns of a basic game into a play or turn of an enhanced game with at least one enhanced attribute unavailable in the basic game.

### BRIEF DESCRIPTION OF THE DRAWINGS

FIG. 1 is a block diagram of a system according to an embodiment of the present invention;

FIG. 2 is a flowchart of a method according to an embodiment of the present invention.

### DESCRIPTION

Reference is now made to the figures wherein like parts are referred to by like numerals throughout. Referring generally to the figures, the present invention includes a system, device, and method for issuing and redeeming bulk quantities of units. Generally stated, the election of a bulk quantity of units results in a benefit provided to accompany the redemption of units from the bulk quantity, where the benefit is provided independent of, and unrelated to, the price of the units.

The units may take any form. In an optional embodiment, the units are digital goods, such as music, movies, books, software, event admissions (e.g., event tickets), games, plays or turns of games, or the like.

The present invention includes various embodiments of systems and devices. The form of the device or devices within the scope of the present invention may vary based on the embodiment. For example, a system may include devices in the form of a mobile phone, personal computer, tablet device, embedded device, gaming machine, kiosk, electronic gaming table, PDA, handheld device, turnstile, or the like.

A system according to embodiments of the present invention includes at least one data processor 102. A data processor 102 may take any form including, but not limited to, a microprocessor, a microcontroller, a digital signal processor, or any combination thereof.

A data processor 102 communicates with a user interface 104. In an optional embodiment, the user interface 104 includes an input device to receive input and transmit the input to the data processor 102. The input device may take any form including, but not limited to, a button panel, keyboard, keypad, mouse, pointer, or the like. In a further optional embodiment, the device may include a display 106 which is integrated with the user interface 104 into a touchscreen. In alternate optional embodiments, the display 106 may be separate from the user interface 104. In optional embodiments including a display 106, the display 106 communicates with the data processor 102. The data processor 102 may control the display 106 directly or via an intermediate device, such as a video controller. The display 106 may take any form including, but not limited to, a liquid crystal display, light emitting diode display, organic light emitting diode display, cathode ray tube monitor, plasma display, or the like.

The data processor 102 communicates with a data storage device 108. The data storage device 108 stores parameters and program instructions to conduct a method according to an embodiment of the present invention. The data storage device 108 may utilize any form of memory or data storage including magnetic data storage, optical data storage, electrical or electronic data storage, Flash memory, or the like. Moreover, it is contemplated that the data storage device 108 may be local to the data processor 102 or remote from the data processor 102, such as in remote or cloud storage.

Referring to FIG. 2, in one such optional embodiment, the program instructions include receiving an election of a first quantity of units or a bulk quantity of units. That is, in one optional embodiment, a user is presented a choice between a first quantity of units or a bulk quantity of units. As used herein, “bulk” simply refers to a plurality of units associated with a benefit, as described in greater detail below, and may refer to any quantity. The first quantity of units may likewise refer to any quantity of units, including one unit. In an optional embodiment, the bulk quantity of units is greater than the first quantity of units. For example, the first quantity of units may be a single unit and a bulk quantity of units may be ten units. It is contemplated that the bulk quantity of units includes multiple units redeemed by a single person, single units redeemed by multiple people, multiple units redeemed by multiple people, or any combination thereof.

In an optional embodiment, an option is displayed 202 at the display 106 of a first quantity of units or a bulk quantity of units and, in response to the displayed option, input may be received 204 through the user interface 104 electing either the first quantity of units or a bulk quantity of units.

If the first quantity of units is elected, the first quantity of units is issued 206 as units from the first quantity of units are redeemed. More specifically, as units from the first quantity of units are redeemed, units are issued without any additional benefit, as described in greater detail below. Thus, in the example in which units are games or plays of a game, the units provided when the first quantity of units is elected and redeemed are basic, unaltered games, which are distinguishable from enhanced games that are provided when a bulk quantity of games is elected and redeemed.

Conversely, if the bulk quantity of units is elected, a bulk quantity of units is issued and a benefit is distributed 208 across one or more of the units. The benefit(s) are applied to units as the units from the bulk quantity of units are redeemed. As used herein, “redeemed” merely refers to the process of using, consuming, or converting the units. This is distinguished from the right to use, consume, or convert the units insofar as the benefit is not necessarily provided for merely electing and/or purchasing a bulk quantity of units. Rather, the benefit is provided when the units are redeemed, e.g., used, consumed, played, viewed, read, or the like. In an optional embodiment, the units are digital goods, such as music, movies, games, plays or turns of a game, books, or the like, stored at the data storage device 108. In an alternate optional embodiment, the units may be digital goods stored elsewhere, such as a retail website, file server, content server, digital file exchange, cloud server, or the like, and either the digital good, or access to the digital good, is provided to the user. In an optional embodiment, redemption occurs at the device with a command to redeem units from a bulk quantity of units received at the data processor 102 from a user interface 104. For example, a bulk quantity of digital goods may be elected and redeemed at a mobile phone, personal computer, electronic gaming machine, game console, tablet device, kiosk, or the like.

In another optional embodiment, a plurality of data processors 102 operate in a system with one data processor 102 receiving the election of a bulk quantity of units and another data processor 102 receiving the command to redeem the bulk quantity of units. For example, the bulk quantity of units may be selected at a kiosk, mobile phone, tablet device, personal computer, or the like, and a command to redeem units may be received at a turnstile, electronic gaming machine, game console, or the like.

It is contemplated that additional bulk quantities of games may be offered with additional or alternate benefits. For example, a first benefit may be applied when a user elects a first bulk quantity of units, a second benefit (separately or in addition to the first benefit) may be applied when a user elects a second bulk quantity of units, and so forth. Thus, for example, a single unit may be elected for no benefits, ten units may be elected for benefit X, twenty units may be elected for benefit Y, or fifty units may be elected for benefits X and Y.

In an optional embodiment, the benefit is independent of price, i.e., is not a discount. For example, in an optional embodiment, the benefit is not merely a discounted bulk price that is less than the unit price multiplied by the bulk quantity of units. In an example in which the units are games or plays of a game, a first quantity of units may represent a single game or play of a game for one dollar and a bulk quantity of units may represent ten games or plays of a game for ten dollars, i.e., the benefit is independent of price and is not a discount. In a further optional embodiment, the bulk quantity of units may be offered at a price greater than the unit price multiplied by the bulk quantity of units. For example, a single game or play of a game may be associated with a unit price of one dollar, and a bulk quantity of ten games may be associated with a bulk price of twelve dollars since the benefit applied to the bulk quantity of ten games may provide additional value to justify additional cost.

The benefit may be distributed across one or more designated units within the bulk quantity of units. In an optional embodiment, the benefit is distributed across the plurality of units within the bulk quantity of units. Thus, the benefit may be applied throughout the units of the bulk quantity of units, or applied to each individual unit within the bulk quantity of units, or applied to specific units within the bulk quantity of units, or any combination thereof. For example, a benefit may be applied (automatically or in response to input through the user interface 104) to all of the units of the bulk quantity of units as they are redeemed. In another example, a benefit may be applied (automatically or in response to input through the user interface 104) to each individual unit of the bulk quantity of units as they are redeemed. Such an example, may permit varying of benefits based on which unit is redeemed, the timing of the redemption (e.g., the day or time of redemption, the rate of redemption, or the like), or other factors surrounding redemption. In yet another example, a benefit may be applied (automatically or in response to input through the user interface 104) to specific units of the bulk quantity of units as they are redeemed.

In an optional embodiment, applied benefits may be exhaustible. In such an example, applying a benefit to one unit of the bulk quantity of units may affect the applicability of the benefit to another unit in the bulk quantity of units. For example, benefit A may be distributed across ten units, but application of benefit A in the first unit of the bulk quantity exhausts benefit A such that benefit A is unavailable to be applied to any of the remaining nine units. Similarly, in another example, ten iterations of benefit B may be distributed across ten units, which would allow a maximum of ten applications of benefit B in any combination across the ten units, with benefit B exhausted after the tenth application (whether the tenth application occurs in the first unit, tenth unit, or any other unit).

In an alternate optional embodiment, the benefits may be distributed and applied such that they are non-exhaustible. Thus, whether or not the benefit is applied in any single unit within the bulk quantity does not affect or otherwise exhaust the benefit applied to another other unit within the bulk quantity. For example, as described above, one or more benefits may be distributed to be available across an entire bulk quantity of units, e.g., benefit C is available over a ten-unit bulk quantity of units. In another example, one or more benefits may be distributed to be available in specific units, e.g., benefit D is available in a first unit, benefit E is available in a second unit, and so forth. In either of these examples, application and/or use of a benefit for any single unit does not affect the application or use of the same or other benefits within the bulk quantity of units. It is contemplated that the benefits may be consistent or unchanging over the units of the bulk quantity of units or may differ or change across units of the bulk quantity of units.

For example, a benefit may be scheduled within units of a bulk quantity of units. Where units are event admissions such as theme park admissions or season tickets, different benefits may be scheduled based on location, day of the week, day of the month, or the like to attempt to drive attendance. Thus, in one example, benefits may be offered for units redeemed at alternate venues to steer users from heavily attended events. Conversely, greater or different benefits may be offered for units redeemed during lighter attended days of the week, days of the month, seasons of the year, or the like. In yet a further optional embodiment, benefits may be scheduled by the user to customize the benefits applied when a unit is redeemed.

The benefit itself may be separate from the units or may be integral to units. For example, in one optional embodiment, units are basic units with basic attributes. Application of a benefit converts a basic unit to an enhanced unit with an enhanced attribute that is unavailable in a basic unit.

Thus, in an example in which the units are games or plays of a game, election of a first quantity of units may result in issuance of a basic game with basic attributes whereas election of a bulk quantity of games may result in issuance of enhanced games with one or more enhanced attributes unavailable in the basic game. In one such example applied to a gambling game, enhanced attributes could include such features as additional or different winning outcomes (e.g., additional or different cards, reels, wheels, dice, tiles, numbers, balls, or the like; additional or different symbols on the cards, reels, wheels, dice, tiles, numbers, balls, or the like; or additional or different winning outcomes within a pay table), enhanced pay tables (e.g., greater or additional payouts for outcomes), additional or different bonus or side wager opportunities, additional or different options for using player points within a game, additional or different options to activate optional game features (e.g., additional or different “sixth coin” features that may be bought to be activated), options to acquire additional benefits (e.g., exchanging player points, units, benefits, or the like for alternative or additional benefits), or the like.

In one example, a game may be offered at a device, such as a personal computer, mobile phone, tablet device, electronic gaming machine, kiosk, or the like. The device may display an option to elect either a single game or a bulk quantity of ten games. In selecting the bulk quantity of ten games, the fee, if any, for the ten games may be assessed (e.g., charged, deducted from a stored account or register of credits, or the like). A benefit may be applied to the ten games as they are redeemed, i.e., conducted. In this regard, the games must be redeemed to realize the benefit(s). As noted above, in an optional embodiment, the single game may be a basic game, while the benefit may convert one or more of the games within the bulk quantity into enhanced games with enhanced features not available in the basic game.

While certain embodiments of the present invention have been shown and described it is to be understood that the present invention is subject to many modifications and changes without departing from the spirit and scope of the claims presented herein.

1. A system comprising:
at least one data processor;
a user interface in communication with said data processor; and
a data storage device in communication with said data processor, said data storage device storing program instructions executable by said data processor to conduct the steps of:
receiving an election through said user interface of one of a first quantity of units and a bulk quantity of units, wherein said bulk quantity of units is defined independent of time;
issuing by said data processor said bulk quantity of units and at least one benefit distributed over one or more designated units within said bulk quantity of units when said bulk quantity of units is elected, wherein said benefit is automatically provided when said bulk quantity of units is elected;
receiving a command through said user interface to redeem units from said bulk quantity of units and applying said benefit to one or more of said units when said bulk quantity of units is elected, wherein applying said benefit to any one unit within said bulk quantity of units does not exhaust said benefit distributed to any other unit within said bulk quantity of units; and
issuing by said data processor said first quantity of units without said benefit when said first quantity of units is elected, such that said benefit is only available to be applied to said units when said bulk quantity of units is elected.

2. The system of claim 1 further comprising a display in communication with said data processor and wherein said program instructions further comprise displaying an option at said display to elect one of a first quantity of units and a bulk quantity of units.

3. The system of claim 1 wherein each unit comprises a digital good stored at said data storage device.

4. The system of claim 1 wherein each unit comprises a basic digital good stored at said data storage device, said basic digital good comprising at least one basic digital good attribute, and wherein said benefit comprises converting at least one of said basic digital goods within said bulk quantity of units into an enhanced digital good comprising at least one enhanced attribute unavailable in said basic digital good.

5. A system comprising:
at least one data processor;
a user interface in communication with said data processor; and
a data storage device in communication with said data processor, said data storage device storing program instructions executable by said data processor to conduct the steps of:
receiving an election through said user interface of one of a first quantity of units and a bulk quantity of units, wherein said bulk quantity of units is defined independent of time;
issuing by said data processor said bulk quantity of units and at least one benefit distributed over a plurality of said bulk quantity of units when said bulk quantity of units is elected and redeemed, wherein said benefit is automatically provided when said bulk quantity of units is elected;
receiving a command through said user interface to redeem units from said bulk quantity of units and applying said benefit to said plurality of said units when said bulk quantity of units is elected; and
issuing by said data processor said first quantity of units without said benefit when said first quantity of units is elected, such that said benefit is only available to be applied to said units when said bulk quantity of units is elected.

6. The system of claim 5 further comprising a display in communication with said data processor and wherein said program instructions further comprise displaying an option at said display to elect one of a first quantity of units and a bulk quantity of units.

7. The system of claim 5 wherein said step of applying said benefit further comprises applying said benefit to any one unit within said bulk quantity of units without exhausting said benefit distributed to any other unit within said bulk quantity of units.

8. The system of claim 5 wherein each unit comprises a basic digital good stored at said data storage device, said basic digital good comprising at least one basic digital good attribute, and wherein said benefit comprises converting at least one of said basic digital goods within said bulk quantity of units into an enhanced digital good comprising at least one enhanced attribute unavailable in said basic digital good.

9. The system of claim 8 wherein each digital good comprises at least one event admission.

10. The system of claim 8 wherein each digital good comprises at least one game stored at said data storage device.

11. The system of claim 8 wherein each digital good comprises a turn to conduct a game stored at said data storage device.

12. The system of claim 5 wherein each unit comprises a basic game stored at said data storage device, said basic game comprising at least one basic game attribute, and wherein said benefit comprises converting at least one of said basic games within said bulk quantity of units into an enhanced game comprising at least one enhanced attribute unavailable in said basic game.

13. A system comprising:
at least one data processor;
a user interface in communication with said data processor; and
a data storage device in communication with said data processor, said data storage device storing program instructions executable by said data processor to conduct the steps of:
receiving an election through said user interface of one of a first quantity of units and a bulk quantity of units, wherein said bulk quantity of units is defined independent of time;
issuing by said data processor said bulk quantity of units and at least one benefit distributed over a plurality of said bulk quantity of units when said bulk quantity of units is elected and redeemed, wherein said benefit is automatically provided when said bulk quantity of units is elected;
receiving a command through said user interface to redeem units from said bulk quantity of units and applying said benefit to said plurality of said units when said bulk quantity of units is elected, wherein applying said benefit to any one unit within said bulk quantity of units does not exhaust said benefit distributed to any other unit within said bulk quantity of units; and
issuing by said data processor said first quantity of units without said benefit when said first quantity of units is elected, such that said benefit is only available to be applied to said units when said bulk quantity of units is elected.

14. The system of claim 13 further comprising a display in communication with said data processor and wherein said program instructions further comprise displaying an option at said display to elect one of a first quantity of units and a bulk quantity of units.

15. The system of claim 13 wherein said step of applying said benefit further comprises applying said benefit to any one unit within said bulk quantity of units without exhausting said benefit distributed to any other unit within said bulk quantity of units.

16. The system of claim 13 wherein each unit comprises a basic digital good stored at said data storage device, said basic digital good comprising at least one basic digital good attribute, and wherein said benefit comprises converting at least one of said basic digital goods within said bulk quantity of units into an enhanced digital good comprising at least one enhanced attribute unavailable in said basic digital good.

17. (canceled)

18. The system of claim 16 wherein each digital good comprises at least one game stored at said data storage device.

19. The system of claim 16 wherein each digital good comprises a turn to conduct a game stored at said data storage device.

20. The system of claim 13 wherein each unit comprises a basic game stored at said data storage device, said basic game comprising at least one basic game attribute, and wherein said benefit comprises converting at least one of said basic games within said bulk quantity of units into an enhanced game comprising at least one enhanced attribute unavailable in said basic game.

21. The system of claim 5 wherein a limited quantity of benefits are available to be applied and said step of applying said benefit further comprises depleting said benefits as said benefit is applied to one unit within said bulk quantity of units, thereby exhausting said benefit from being applied to any other unit within said bulk quantity of units.
